(19) United States
(12) Patent Application Publication
(10) Pub. No.: US 2025/0308732 A1
(43) Pub. Date: Oct. 2, 2025

(54) CERAMIC COMPONENT

(71) Applicant: Panasonic Intellectual Property Management Co., Ltd., Osaka (JP)

(72) Inventors: YUTO AKIYAMA, Hokkaido (JP); YUJI YAMAGISHI, Hokkaido (JP); KEIJI KAWAJIRI, Hokkaido (JP)

(21) Appl. No.: 19/038,675

(22) Filed: Jan. 27, 2025

(30) Foreign Application Priority Data
Mar. 28, 2024 (JP) 2024-054686

(51) Int. Cl. H01C 7/102; H01C 1/028; H01C 1/142; H01C 7/112

(52) U.S. Cl. CPC H01C 7/102; H01C 1/028; H01C 1/142; H01C 7/112

(57) ABSTRACT

A ceramic component includes a ceramic body, internal electrodes inside the ceramic body, a first external electrode disposed on a first end surface of the ceramic body and extending from the first end surface to cover a part of a first side surface of the ceramic body, a second external electrode disposed on a second end surface of the ceramic body and extending from the second end surface to cover a part of the first side surface, and a third external electrode disposed on the first side surface of the ceramic body and extending from the first side surface to cover parts of first and second main surfaces of the ceramic body. The ceramic body contains particular element that is at least one of alkali metal and alkaline earth metal. In a surface layer of the first side surface of the ceramic body, a first total concentration of the particular element in a vicinity of the first external electrode and in a vicinity of the second external electrode is different from a second total concentration of the particular element in a vicinity the third external electrode.

### TECHNICAL FIELD

The present disclosure relates to a ceramic component, and it specifically relates to a ceramic component including a ceramic body.

### BACKGROUND ART

Ceramic components, such as varistors, are used in electronics and electronic devices. Varistors are used for protecting electronics and electronic devices from abnormal voltages caused by lightning surge or static electricity to prevent malfunction of electronics and electronic devices due to noise generated in circuits.

Japanese Patent Laid-Open Publication No. 2020-096075 discloses a chip varistor. This chip varistor includes a body having a laminated structure, first and second conductors extending inside the body, a third conductor located between the first conductor and the second conductor and extending to form first and second functional layers, first, second, and third electrodes connected to the conductors, respectively, and an alkali metal-containing portion that is a portion of the body containing alkali metal and thus having large electrical resistance. The alkali metal-containing portion constitutes the surface of the body and extends inward from the surface of the body along the interface between the body and each of the conductors. The chip varistor is characterized in that the alkali metal-containing portion does not reach the first functional layer and the second functional layer. In this chip varistor, the electrical resistance is increased due to alkali metal disposed along an entire outer surface of the body.

### SUMMARY

In conventional ceramic components, when the alkali metal disposed on the entire outer surface of the ceramic body as in the chip varistor disclosed in Japanese Patent Laid-Open Publication No. 2020-096075 may cause migration on the surface of the ceramic body.

A ceramic component according to an aspect of the disclosure includes: a ceramic body having a first end surface and a second end surface opposite to each other in a first direction, a first side surface and a second side surface opposite to each other in a second direction, and a first main surface and a second main surface opposite to each other in a third direction; internal electrodes disposed inside the ceramic body; a first external electrode disposed on the first end surface of the ceramic body and extending from the first end surface of the ceramic body to cover a part of the first side surface; a second external electrode disposed on the second end surface of the ceramic body and extending from the second end surface to cover a part of the first side surface of the ceramic body; and a third external electrode disposed on the first side surface of the ceramic body and extending from the first side surface side to cover a part of the first main surface and a part of the second main surface of the ceramic body. The ceramic body contains particular element that is at least one of alkali metal and alkaline earth metal. A first total concentration of the particular element in a vicinity of the first external electrode in a surface layer of the first side surface of the ceramic body and a vicinity of the second external electrode in the surface layer of the first side surface of the ceramic body is different from a second total concentration of the particular element in a vicinity of the third external electrode in the surface layer of the first side surface of the ceramic body.

The ceramic component according to the disclosure has migration suppressing properties enhanced.

### BRIEF DESCRIPTION OF DRAWINGS

FIG. 1 is a schematic perspective view of a ceramic component of an exemplary embodiment.

FIG. 2 is a schematic cross-sectional view of the ceramic component shown in FIG. 1.

FIG. 3 is a schematic perspective view of the ceramic component shown in FIG. 1.

### DESCRIPTION OF EMBODIMENTS

### 1. Overview

An overview of ceramic component 1 will be described below with reference to the drawings. The drawings are schematic views, and the size and thickness ratios of each constituent element in the drawings do not necessarily reflect the actual dimensional ratios.

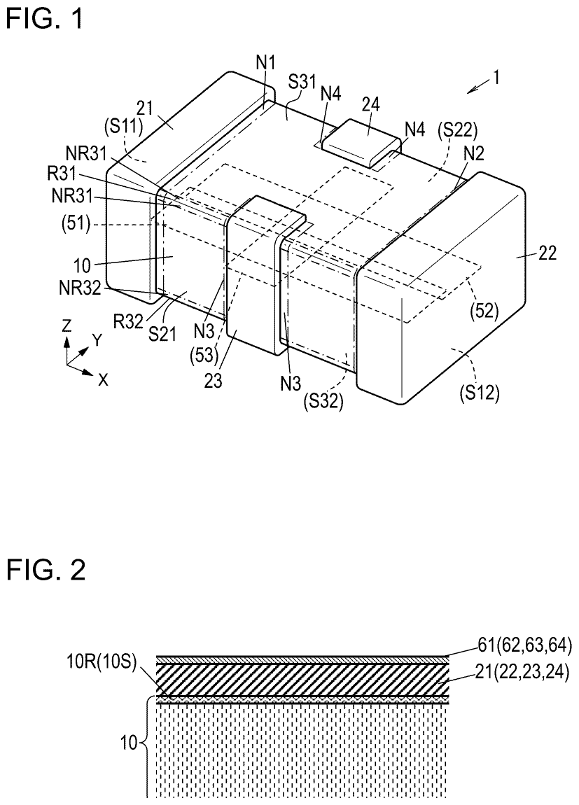

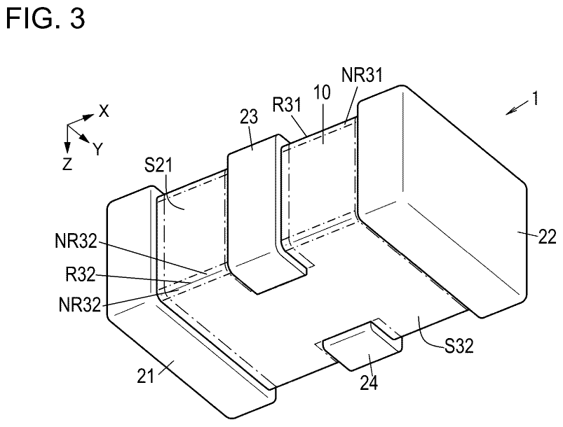

FIG. 1 is a schematic perspective view of ceramic component 1 according to an exemplary embodiment. FIG. 2 is a schematic cross-sectional view of ceramic component 1. FIG. 3 is a schematic perspective view of ceramic component 1.

In the following description, as shown in FIG. 1, an X-axis direction parallel to a longitudinal direction of ceramic body 10 is defined as a first direction, a Y-axis direction is defined as a second direction, and a Z-axis direction is defined as a third direction. These directions are merely examples, and are not intended to limit the orientation of ceramic component 1 in operation.

As a result of extensive research aimed at solving the above problems, inventors have found that the distribution of the concentration of particular element which is at least one of alkali metal and alkaline earth metal corelates to characteristics of the ceramic component, and accomplished the disclosure.

The term “particular element” encompasses alkali metal, such as lithium, sodium, potassium, rubidium, and cesium, and alkaline earth metal, such as beryllium, magnesium, calcium, strontium, and barium. Among them, sodium, potassium, magnesium, and calcium are preferable.

As shown in FIG. 1, ceramic component 1 according to this embodiment includes ceramic body 10, internal electrodes 51, 52, and 53, and external electrodes, that is, first external electrode 21, second external electrode 22, and third external electrode 23.

Ceramic body 10 has first end surface S11 and second end surface S12 opposite to each other in the first direction (X-axis direction), first side surface S21 and second side surface S22 opposite to each other in the second direction (Y-axis direction), and first main surface S31 and second main surface S32 opposite to each other in the third direction (Z-axis direction).

First external electrode 21 is disposed on first end surface S11 and extends from the first end surface S11 to cover a part of first side surface S21. Second external electrode 22 is disposed on second end surface S12 and extends from the second end surface S12 to cover a part of first side surface S21. Third external electrode 23 is disposed on first side surface S21 and extends from the first side surface S21 to cover respective parts of first main surface S31 and second main surface S32.

First external electrode 21 and second external electrode 22 are external electrodes disposed on end surfaces S11 and S12 of ceramic body 10, respectively, (hereinafter also referred to as end surface electrodes). Third external electrode 23 is an external electrode disposed on side surface S21 of ceramic body 10 (hereinafter also referred to as a side surface electrode).

As shown in FIG. 1, ceramic body 10 includes, as external electrode vicinity regions, first external electrode vicinity N1 and second external electrode vicinity N2 that are vicinities of first external electrode 21 and second external electrode 22, respectively, which are end surface electrodes. In addition, ceramic body 10 further includes third external electrode vicinity N3 that is a vicinity of third external electrode 23, which is a side surface electrode, and fourth external electrode vicinity N4 that is a vicinity of fourth external electrode 24, which is a side surface electrode. The term “external electrode vicinity” refers to a region of the ceramic body that is within a distance of 50 μm from an end of an external electrode in the first direction (X-axis direction) and is connected to the external electrode.

In ceramic component 1 according to this embodiment, ceramic body 10 contains the particular element. A first total concentration of the particular element in first external electrode vicinity N1 in surface layer 10S of first side surface S21 and second external electrode vicinity N2 in surface layer 10S is different from a second total concentration of the particular element in third external electrode vicinity N3 in surface layer 10S. In other words, regarding the concentration of the particular element in surface layer 10S of first side surface S21 of ceramic component 1, the concentration (the first total concentration) in the end surface electrode vicinities is different from the concentration (the second total concentration) in the side surface electrode vicinities.

The “surface layer 10S” is a region with a depth from the surface is within the detection depth detectable by an Electron Probe Micro Analyzer (EPMA). The EPMA is a measuring apparatus configured to analyze constituent elements based on wavelengths and intensities of characteristic X-rays generated by electron beam irradiation of an object to be measured, and the detectable depth is within a range of 0.1 μm or more and 10 μm or less, preferably within a range of 0.5 μm or more and 2 μm or less, and the depth is more preferably 1 μm.

The “total concentration” of the particular element refers to the whole concentration of the particular element in the external electrode vicinities in surface layer 10S of first side surface S21. The “whole concentration” means a percentage (wt. %) of the whole weight of the particular element contained in a portion of the ceramic body with a certain volume with respect to the weight of the portion of the ceramic body. With respect to the “total concentration”, in the measurement with the EPMA, for example, the percentage of the whole peak area of the particular element with respect to the peak area of elemental Zn of ZnO, which is a main component of the ceramic body, (whole peak area of the particular element×100/peak area of elemental Zn) may be calculated to determine an approximation of the total concentration. The expression “total concentrations are different” means that the first total concentration and the second total concentration are different from each other by 5 wt. % or more.

In ceramic component 1 according to this embodiment, the first total concentration is different from the second total concentration, in other words, the concentration in respective vicinities of the end surface electrodes is different from the concentration in respective vicinities of the side surface electrodes, thereby enhancing the migration suppressing properties. A reason why ceramic component 1 according to this embodiment exhibits this effect as a result of the above configuration may be, for example, that the particular element is provided locally in the external electrode vicinities, or the overall abundance of the particular element is reduced.

In addition, in ceramic component 1 according to this embodiment, as described later, the difference between the concentration in the vicinities of the end surface electrodes and the concentration in the vicinities of the side surface electrodes, the concentration of the particular element in a particular region enhance migration suppressing properties while also enhancing, e.g., sealing properties, plating flow suppressing and properties, moisture resistance.

### 2. Details

### Ceramic Component

Ceramic component 1 according to the disclosure includes ceramic body 10, the internal electrodes, and the external electrodes, that is, first external electrode 21, second external electrode 22, and third external electrode 23. As shown in FIG. 1, ceramic component 1 includes fourth external electrode 24 disposed on second side surface S22 and extending from the second side surface S22 to cover respective parts of first main surface S31 and second main surface S32. Third external electrode 23 and fourth external electrode 24 in FIG. 1 may be connected to each other on first main surface S31 and second main surface S32 to extending entirely around ceramic body 10. Ceramic component 1 may further include a plating electrode covering at least part of the surface of each of external electrodes 21, 22, 23, and 24.

Ceramic component 1 according to the disclosure may be, for example, a varistor, a thermistor, or a ceramic capacitor. As an example, ceramic component 1 according to the disclosure configured to function as varistor 1 will be described below.

### Ceramic Body

Ceramic body 10 of varistor 1 according to this embodiment has, for example, a rectangular shape with a long side extending in the first direction (X-axis direction). Ceramic body 10 has dimensions, for example: the length in the first direction (X-axis direction) ranges from 0.6 to 1.6 mm, the length (width) in the second direction (Y-axis direction) ranges from 0.3 to 0.8 mm, and the length (height) in the third direction (Z-axis direction) ranges from 0.3 to 0.8 mm. Corners of ceramic body 10 may be chamfered, and the corners of ceramic body 10 may be rounded.

In varistor 1, ceramic body 10 is made of, for example, semiconductor ceramic components having non-linear resistance characteristics. Ceramic body 10 contains ZnO as a main component, and may further contain, e.g., Bi₂O₃, Co₂O₃, MnO₂, Sb₂O₃, Pr₆O₁₁, CaCO₃, or Cr₂O₃ as auxiliary component. In the semiconductor ceramic components, the main component, such as ZnO, is dissolved and sintered with some of auxiliary components, and the remaining auxiliary components are precipitated at grain boundaries, thereby forming ceramic body 10.

Regarding the concentration of the particular element in surface layer 10S of first side surface S21 of varistor 1 of this embodiment, the first total concentration in first external electrode vicinity N1 and second external electrode vicinity N2 is different from the second total concentration in third external electrode vicinity N3. This configuration provides varistor 1 with high migration suppressing properties.

The particular element contained in external electrode vicinities N1-N4 in ceramic body 10 has been diffused from an external electrode paste into ceramic body 10 during, for example, baking for forming the external electrodes during varistor 1 production process. Therefore, the first total concentration and the second total concentration of the particular element may be adjusted by, between the end surface electrodes and the side surface electrodes, for example, (1) changing the number of times the external electrode paste is applied or baked; (2) changing the baking temperature or time; or (3) using external electrode pastes having different particular element contents.

Ceramic body 10 may include insulating layer 10R at surface layer 10S (see FIG. 2). In other words, insulating layer 10R, that is, a high-resistance region with a layer shape may be formed at surface layer 10S of ceramic body 10. In this case, ceramic body 10 contains the particular element in surface layer 10S and has insulating layer 10R disposed at the surface layer further enhances the migration suppressing properties.

### Internal Electrode

Internal electrodes 51-53 are disposed inside ceramic body 10. The number of the internal electrodes in varistor 1 shown in FIG. 1 is, for example, three. Internal electrode 51 is electrically connected to first external electrode 21, is an end surface electrode. Internal electrode 52 is electrically connected to second external electrode 22, an end surface electrode. Internal electrode 53 is electrically connected to third external electrode 23 and fourth external electrode 24, side surface electrodes.

Internal electrodes 51-53 contain metal, such as Ag, Pd, PdAg, or PtAg. Ceramic body 10 having internal electrodes 51 to 53 inside can be prepared, for example, by applying an internal electrode paste containing the above metal onto ceramic sheets by, e.g., printing, after preparing the ceramic sheets with a ZnO-containing slurry. Then the ceramic sheets with the internal electrode pastes applied thereon are stacked, pressed, and cut. Then, binder in the ceramic sheets is removed at a temperature of, e.g., 300° C. or more and 500° C. or less. Then, the ceramic sheets are baked at a temperature of, e.g., 600° C. or more and 1,100° C. or less.

### External Electrode

As shown in FIG. 1, varistor 1 includes first external electrode 21 and second external electrode 22 as end surface electrodes, and third external electrode 23 and fourth external electrode 24 as side surface electrodes.

First external electrode 21 is disposed on first end surface S11 and extends from the first end surface S11 to cover a part of first side surface S21. Second external electrode 22 is disposed on second end surface S12 and extends from the second end surface S12 to cover a part of first side surface S21. Third external electrode 23 is disposed on first side surface S21 and extends from the first side surface S21 to cover a part of first main surface S31 and a part of second main surface S32. Fourth external electrode 24 is disposed on second side surface S22 and extends from the second side surface S22 to cover a part of first main surface S31 and a part of second main surface S32.

External electrodes 21, 22, 23, and 24 are formed by, for example, applying an external electrode paste containing metal component, such as Ag, AgPd, or AgPt, and glass component, such as Bi₂O₃, SiO₂, or B₂O₃ by, e.g., immersion or printing so as to partially cover end surfaces S11 and S12, side surfaces S21 and S22, and main surfaces S31 and S32 of ceramic body 10, followed by baking the paste at a temperature of, e.g., 700° C. or more and 800° C. or less.

### Plating Electrode

Plating electrodes 61, 62, 63, and 64 cover at least respective parts of external electrodes 21, 22, 23, and 24, respectively. Each plating electrode may include, for example, an Ni electrode covering at least a part of each external electrode and an Sn electrode covering at least a part of the Ni electrode. Plating electrodes 61, 62, 63, and 64 are formed by immersing, in a plating solution, ceramic body 10 having external electrodes 21, 22, 23, and 24 thereon. In a conventional ceramic component, during the formation of a plating electrode, the plating solution may contact a surface of the ceramic body, resulting in so-called plating flow, in which the plating electrode protrudes from the external electrode and spreads onto the surface of ceramic body 10.

Ceramic component 11, such as a thermistor or a ceramic capacitor, according to this embodiment other than varistor 1 also has migration suppressing properties enhanced.

Ceramic component 1 according to first to third exemplary embodiments will be described below.

### First Exemplary Embodiment

In ceramic component 1 according to according to the first embodiment, the second total concentration is higher than the first total concentration. In other words, the concentration of the particular element in the vicinities of the side surface electrodes is higher than the concentration in the vicinities of the end surface electrodes. The concentration in the vicinities of the side surface electrodes may become higher than the concentration in the vicinities of the end surface electrodes by: (A) making the concentration (wt. %) of the particular element in the external electrode paste higher in the side surface electrodes than in the end surface electrodes; (B) making the number of times the external electrodes are baked greater in the side surface electrodes than in the end surface electrodes; or (C) making the conditions for baking the external electrodes to be a higher temperature and/or a longer time in the side surface electrodes than in the end surface electrodes, etc.

Ceramic component 1 according to the first embodiment is advantageous in that, in addition to the enhanced migration suppressing properties described above, the sealing properties against the plating solution and flux during mounting are enhanced, and the plating flow suppressing properties is enhanced. In other words, ceramic component 1 according to the first embodiment may also enhance migration suppressing properties, sealing properties, and plating flow suppressing properties.

The effect enhancing sealing properties is due to the following reason, for example: a large amount of glass containing the particular element provided in the vicinity of the side surface electrodes, where sealing properties have been conventionally degraded, enhances the sealing properties against the plating solution, and flux during mounting. In addition, the plating flow suppressing properties is enhanced due to the following reason: a large amount of the particular element with no free electrons provided on the side surface electrodes, where plating flow have conventionally occurred, prevents Ni ions and Sn ions in the plating solution from receiving electrons in the vicinity of the external electrodes.

The second total concentration is preferably 1.2 times or more the first total concentration. This configuration further enhances the migration suppressing properties, sealing properties, and plating flow suppressing properties. The second total concentration is more preferably 1.4 times or more, still more preferably 1.5 times or more, and particularly preferably 1.7 times or more the first total concentration. The upper limit of the second total concentration is not particularly limited, but may be, for example, 3.0 times or less, and preferably 2.0 times or less the first total concentration.

### Second Exemplary Embodiment

In ceramic component 1 according to a second exemplary embodiment, the first total concentration is higher than the second total concentration. In other words, the concentration of the particular element in the vicinities of the end surface electrodes is higher than the concentration in the vicinities of the side surface electrodes.

Ceramic component 1 according to the second embodiment provides an advantageous effect also enhancing the moisture resistance in addition to the migration suppressing properties described above. In other words, ceramic component 1 according to the second embodiment enhances both of migration suppressing properties and improved moisture resistance.

The enhancing of the moisture resistance is due to the following reason: while a surface insulation degradation during a moisture load test have conventionally occurred at an end surface electrode vicinity serving as the starting point of the reaction, a large amount of glass containing the particular element in the vicinities of end surface electrodes protect the starting point of the surface degradation.

The first total concentration is preferably 1.2 times or more the second total concentration. This configuration further enhances the migration suppressing properties and moisture resistance. The first total concentration is more preferably 1.4 times or more, still more preferably 1.5 times or more, and particularly preferably 1.7 times or more the second total concentration. The upper limit of the first total concentration is not particularly limited, but may be, for example, 3.0 times or less, and preferably 2.0 times or less the second total concentration.

### Third Exemplary Embodiment

In ceramic component 1 according to a third exemplary embodiment, ceramic body 10 includes particular ridge portion NR31 and particular ridge portion NR32. Particular ridge portion NR31 includes ridge R31 between first side surface S21 and first main surface S31. Particular ridge portion NR32 includes ridge R32 between first side surface S21 and second main surface S32. In ceramic component 1 according to the third embodiment, the total concentration of the particular element in particular ridge portions NR31 and NR32 is higher than the total concentration of the particular element in surface layer 10S of first side surface S21. In other words, in ceramic component 1 according to the third embodiment, the concentration of the particular element in the ridge portion (particular ridge portion NR31) between first side surface S21 and first main surface S31 in ceramic body 10 and the ridge portion (particular ridge portion NR32) between first side surface S21 and second main surface S32 in ceramic body 10 is higher than the concentration in entire surface layer 10S of first side surface S21. The particular ridge portions are: a region of ceramic body 10 that is within 50 μm from ridge R31 connecting first side surface S21 to first main surface S31 and that is connected to ridge R31 forming surface layer 10S; and a region of ceramic body 10 that is within 50 μm from ridge R32 connecting first side surface S21 to second main surface S32 and that is connected to ridge R32 forming surface layer 10S. Similar to first side surface S21, ceramic body 10 includes a particular ridge portion including a ridge between second side surface S22 and first main surface S31, and further includes a particular ridge portion including a ridge between second side surface S22 and second main surface S32. The total concentration in these particular ridge portions is higher than the total concentration of the particular element in surface layer 10S of second side surface S22.

Ceramic component 1 according to the third embodiment provides an advantageous effect enhancing the plating flow suppressing properties in addition to the migration suppressing properties described above. In other words, ceramic component 1 according to of the third embodiment enhances both of migration suppressing properties and improved plating flow suppressing properties.

The effect enhancing migration suppressing properties and plating flow suppressing properties is due to the following reason, for example: while migration have conventionally occurred on the body surface and plating flow have been conventionally occurred at ridge portions of the body, a large amount of the particular element on the ridge portions provide this effect.

### EXAMPLES

The disclosure will be described below with reference to examples, but the disclosure is not limited to the examples.

### Production of Ceramic Component

A ceramic body containing ZnO as a main component was formed, and insulating layer 10R made of SiO₂ was formed as surface layer 10S of the ceramic body. Subsequently, an external electrode paste was applied to a surface of insulating layer 10R and baked, thereby producing ceramic components of Examples 1 and 2 and Comparative Example 1.

### Example 1

In the ceramic component of Example 1, the side surface electrodes were made of an Ag paste containing elemental K-containing glass frit with 0.45 wt. % of the elemental K content in the Ag paste. The end surface electrodes were made of an Ag paste containing an elemental K-containing glass frit with 0.225 wt. % of the elemental K content in the Ag paste. These Ag pastes were applied onto the side and end surfaces, respectively, then dried, and baked at 700° C. for 6 minutes (temperature rise rate: 30° C./min).

### Example 2

In the ceramic component of Example 2, the same external electrode paste for the side surface electrodes as Example 1 was applied to the side surfaces and then baked at 700° C. for 6 minutes (temperature rise rate: 30° C./min) to form the side surface electrodes. Subsequently, the same external electrode paste as the side surface electrodes was applied to the end surfaces, and then baked under the same conditions as baking the side surface electrodes, thereby forming the end surface electrodes. That is, in Example 2, the side surface electrodes were made of an external electrode paste containing a large amount of glass component, and baking it twice under conditions with a long baking time, while the end surface electrodes were produced by baking it once under the same conditions.

### Comparative Example 1

The ceramic component of Comparative Example 1 was produced by applying the same external electrode paste containing an Ag powder and not containing the particular element to the side and end surfaces, and followed by baking.

### Evaluation

### Particular Element (Alkali Metal, Alkaline Earth Metal)/Zn Ratio)

The side surface electrode vicinities and end surface electrode vicinities of each ceramic component were measured with an EPMA measuring apparatus for the particular element (elemental K) and elemental Zn, and the peak area ratio thereof was calculated to determine the particular element/Zn ratio (wt. %).

### Plating Flow Rate (%)

With respect to plating flow, the plating flow on the surface of a ceramic component after plating was observed with a metallurgical microscope, and the plating flow rate (%), which is the incidence of the number of ceramic components with plating flow among n ceramic components (n=1,000), was determined.

For the ceramic components of Example 1, Example 2, and Comparative Example 1, the particular element/Zn ratio in the side surface electrode vicinities and end surface electrode vicinities, the side surface electrode vicinity/end surface electrode vicinity ratio, and the plating flow rate (%), which are measured above, are shown in Table 1 below.

TABLE 1

| | Particular element/Zn Ratio | | | Plating Flow |
|---|---|---|---|---|
| | Side Surface | End Surface | Side Surface/ | Rate |
| | Electrode Vicinity | Electrode Vicinity | End Surface Ratio | (%) |
| Example 1 | 4.18 | 2.97 | 1.41 | 1.5 |
| Example 2 | 10 | 5.59 | 1.79 | 0.8 |
| Comparative | 2.73 | 2.66 | 1.03 | 45.2 |
| Example 1 | | | | |

As shown in the results in Table 1, the ceramic components of Examples 1 and 2 have plating flow suppressing properties enhanced compared to the ceramic component of Comparative Example 1.

### SUMMARY

As described in the above embodiments, the disclosure includes the following aspects. In the following description, reference numerals are given in parentheses only to clarify the correspondence with the embodiments.

A ceramic component (1) of a first aspect includes: a ceramic body (10) having a first end surface (S11) and a second end surface (S12) opposite to each other in a first direction (an X-axis direction), a first side surface (S21) and a second side surface (S22) opposite to each other in a second direction (a Y-axis direction), and a first main surface (S31) and a second main surface (S32) opposite to each other in a third direction (a Z-axis direction); internal electrodes (51-53) disposed inside the ceramic body (10); a first external electrode (21) disposed on the first end surface (S11) and extending from the first end surface (S11) to cover a part of the first side surface (S21); a second external electrode (22) disposed on the second end surface (S12) and extending from the second end surface (S12) to cover a part of the first side surface (S21); and a third external electrode (23) disposed on the first side surface (S21) and extending from the first side surface (S21) to cover a part of the first main surface (S31) and a part of the second main surface (S32). The ceramic body (10) contains a particular element that is at least one of alkali metal and alkaline earth metal. A first total concentration of the particular element in the first external electrode vicinity (N1) and the second external electrode vicinity (N2) in a surface layer (10S) of the first side surface (S21) is different from a second total concentration of the particular element in the third external electrode vicinity (N3) in the surface layer (10S) of the first side surface (S21).

According to the first aspect, the ceramic component (1) has migration suppressing properties enhanced.

In a ceramic component (1) of a second aspect, in the first aspect, the second total concentration is higher than the first total concentration.

According to the second aspect, the ceramic component (1) has migration suppressing properties enhanced and further has sealing properties and plating flow suppressing properties enhanced.

In a ceramic component (1) of a third aspect, in the second aspect, the second total concentration is 1.2 times or more the first total concentration.

According to the third aspect, the ceramic component (1) has migration suppressing properties, sealing properties, and plating flow suppressing properties further enhanced.

In a ceramic component (1) of a fourth aspect, in the first aspect, the first total concentration is higher than the second total concentration.

According to the fourth aspect, the ceramic component (1) has migration suppressing properties and improved moisture resistance enhanced.

In a ceramic component (1) of a fifth aspect, in the fourth aspect, the first total concentration is 1.2 times or more the second total concentration.

According to the fifth aspect, the ceramic component (1) has migration suppressing properties and moisture resistance enhanced.

In a ceramic component (1) of a sixth aspect, the ceramic body (10) in any one of the first to fifth aspects includes a first particular ridge portion (NR31) and a second particular ridge portion (NR32). The first particular ridge portion (NR31) includes a ridge (R31) between the first side surface (S21) and the first main surface (S31). The second particular ridge portion (NR32) includes a ridge (R32) between the first side surface (S21) and the second main surface (S32). The total concentration of the particular element in the first particular ridge portion (NR31) and the second particular ridge portion (NR32) is higher than the total concentration of the particular element in the surface layer (10S) of the first side surface (S21).

According to the sixth aspect, the ceramic component (1) has migration suppressing properties and plating flow suppressing properties enhanced.

In a ceramic component (1) of a seventh aspect, the ceramic body (10) in any one of the first to sixth aspects includes an insulating layer (10R) disposed at the surface layer (10S).

According to the seventh aspect, the ceramic component (1) has the migration suppressing properties enhanced.

What is claimed is:

1. A ceramic component comprising:
a ceramic body having a first end surface and a second end surface opposite to each other in a first direction, a first side surface and a second side surface opposite to each other in a second direction, and a first main surface and a second main surface opposite to each other in a third direction;
a plurality of internal electrodes disposed inside the ceramic body;
a first external electrode disposed on the first end surface of the ceramic body and extending from the first end surface of the ceramic body to cover a part of the first side surface;
a second external electrode disposed on the second end surface of the ceramic body and extending from the second end surface to cover a part of the first side surface of the ceramic body; and
a third external electrode disposed on the first side surface of the ceramic body and extending from the first side surface side to cover a part of the first main surface and a part of the second main surface of the ceramic body, wherein
the ceramic body contains particular element that is at least one of alkali metal and alkaline earth metal, and
a first total concentration of the particular element in a vicinity of the first external electrode in a surface layer of the first side surface of the ceramic body and a vicinity of the second external electrode in the surface layer of the first side surface of the ceramic body is different from a second total concentration of the particular element in a vicinity of the third external electrode in the surface layer of the first side surface of the ceramic body.

2. The ceramic component according to claim 1, wherein the second total concentration is higher than the first total concentration.

3. The ceramic component according to claim 2, wherein the second total concentration is 1.2 times or more the first total concentration.

4. The ceramic component according to claim 1, wherein the first total concentration is higher than the second total concentration.

5. The ceramic component according to claim 4, wherein the first total concentration is 1.2 times or more the second total concentration.

6. The ceramic component according to claim 1, wherein
the ceramic body includes a first particular ridge portion and a second particular ridge portion, the first particular ridge portion including a ridge between the first side surface and the first main surface of the ceramic body, the second particular ridge portion including a ridge between the first side surface and the second main surface of the ceramic body, and
a total concentration of the particular element in the first particular ridge portion and the second particular ridge portion is higher than a total concentration of the particular element in the surface layer of the first side surface.

7. The ceramic component according to claim 1, wherein the ceramic body includes an insulating layer disposed at the surface layer.
